(19) United States
(12) Patent Application Publication
(10) Pub. No.: US 2006/0126993 A1
(43) Pub. Date: Jun. 15, 2006

(54) SOI-based optical interconnect arrangement

(75) Inventors: David Piede, Allentown, PA (US); Bipin Dama, Bridgewater, NJ (US); Kalpendu Shastri, Orefield, PA (US); John Fangman, Leesport, PA (US); Harvey Wagner, Macungie, PA (US); Margaret Ghiron, Allentown, PA (US)

Correspondence Address: Wendy W. Koba, PO Box 556, Springtown, PA, 18081, US

(73) Assignee: SiOptical, Inc.

(21) Appl. No.: 11/287,114

(22) Filed: Nov. 25, 2005

Related U.S. Application Data
(60) Provisional application No. 60/630,753, filed on Nov. 24, 2004.
(60) Provisional application No. 60/654,783, filed on Feb. 18, 2005.

(51) Int. Cl. G02B 6/12

(52) U.S. Cl. 385/14

(57) ABSTRACT

An SOI-based optical interconnection arrangement is provided that significantly reduces the size, complexity and power consumption requires of conventional high density electrical interconnections. In particular, a group of optical modulators and wavelength division multiplexers/demultiplexers are used in association with traditional electrical signal paths to “concentrate” a large number of the electrical-pinouts onto one optical waveguide (e.g., fiber). By utilizing a number of such SOI-based signal concentration structures, an optical backplane can be formed that couples all of these concentration structures through one optical substrate and then onto a separate number of output/receiving boards. Additionally, optical gain material may be embedded within the backplane element to further enhance the optical signal quality. The ability to integrate the electrical and optical components within a monolithic SOI-based structure provides for the significant reduction in the overall size of the connection arrangement and, further, reduces the power consumption by about an order of magnitude.

### CROSS-REFERENCE TO RELATED APPLICATION

This application claims the benefit of U.S. Provisional Application No. 60/630,753, filed Nov. 24, 2004 and U.S. Provisional Application No. 60/654,783, filed Feb. 18, 2005.

### TECHNICAL FIELD

The present invention relates to an optical connection arrangement for high density interconnection applications and, more particularly, to a silicon-on-insulator (SOI)-based arrangement that combines the conventional electrical connectors with an optical signal concentration arrangement to reduce the number of physical interconnections at a backplane.

### BACKGROUND OF THE INVENTION

Over the years, there has been a continual increase in the capacities of integrated circuit boards. As the capacities of the individual boards increases, greater numbers of high data rate interconnections between boards have become necessary. The increased need for interboard connections is difficult to satisfy using conventional technology. Higher interconnect densities lead to a greater possibility of crosstalk, as well as difficulties in assembly, inasmuch as the fine pitch of the connectors requires precise alignment with their respective pads on the board across the total length of the connector. Attempts to increase the data rates across the connectors are hampered by the dielectric and resistance losses experienced by conventional interconnect media at increased data rates.

Conventionally, signals that need to be transmitted across boards are routed to the board edge. From there, the signals can be routed to an adjacent board or to a backplane. Current edge connectors may have an interconnect density of approximately fifty connections per inch. By utilizing both sides of the board, the density can be doubled to one hundred connections per inch. It is not uncommon for boards to require between five hundred and one thousand connections, requiring between five to twenty inches of board edge, depending on the configuration of the connectors.

Further exacerbating the need for increased interconnection density is a corresponding increase in the data rate of interboard transmissions. Interconnects carrying high data rate signals also require a ground or power pin to either side to reduce interference with other high data rate signals. The number of signal pins available on the connectors is thus effectively halved for a board that both transmits and receives high data rate signals. Furthermore, systems typically employ low voltage differential signaling to ensure error-free communication and provide EMI/EMC compatibility. This requirement essentially doubles the connection density problem by requiring two interconnections for each signal path.

Additionally, as data rates continue to increase, the distance that a signal may travel error-free decreases as a result of, among other things, signal attenuation and reflection problems. Exotic techniques such as transmitter pre-emphasis and receiver equalization can be employed to increase this distance, but at the significant expense of increased power dissipation.

Attempts at addressing this problem have further involved converting the electrical signals into the optical domain at the point of interconnection. U.S. Pat. No. 6,038,355, entitled “Optical Bus” and issued to Wendell E. Bishop on Mar. 14, 2000, discloses the use of a series of optical beam splitters/combiners with electrical circuits to form the bus. US Patent Application Publication 2005/0036789, published Feb. '7, 2005 for William D. Bjorndahl et al. describes a “free space optical bus” where a significant amount of electrical multiplexing is performing, with the entire set of multiplexed signals used to drive a laser that provides the free space optical output signal.

At least one limitation with all of these prior art optical attempts at reducing high density connections is that they require a significant quantity of separate optical components that need to be connected to the electrical circuitry. The component size and power dissipation values are problematic as well. In applications where there is already limited available space, and “real estate” and “power budget” are prime commodities, these solutions are not considered to be practical.

### SUMMARY OF THE INVENTION

The needs remaining in the prior art are addressed by the present invention, which relates to an optical connection arrangement for high density interconnection applications and, more particularly, to a silicon-on-insulator (SOI)-based arrangement that combines the conventional electrical connectors with an optical signal concentration arrangement to reduce the number of physical interconnections at a backplane.

In a preferred embodiment of the present invention, a plurality of integrated optical modulators and associated laser sources (which may or may not be integrated within the same SOI substrate) are utilized to convert a plurality of electrical signals into optical representations. The optical signals are then multiplexed together and coupled onto a single optical communication path (e.g. fiber, waveguide, etc.) that is able to carry the entire plurality of original electrical signals. This “condensing” of a large plurality of electrical signals into one optical signal is then performed for each SOI-based structure within a system, where a relatively small plurality of optical paths/(fibers) are then used to form an optical backplane for transporting all of the signals from one “box” to another. A companion optical demultiplexing arrangement is used at the “receiving” box to retrieve the original electrical data signals from the transported, concentrated optical signals.

It is a significant aspect of the present invention that advances in silicon-on-insulator (SOI) technology allow for a large majority of the required optical components to be integrated in the same substrate as the electronic components. This integration allows for a significant reduction in the overall size of the connection arrangement. Moreover, the power dissipation is significantly reduced over prior art arrangements requiring the use of discrete components.

A further aspect of the present invention is that an in-substrate optical gain material (such as a rare-earth material) may be included within the optical backplane to add gain to the optical signals as they propagate through a series of optical taps formed within the backplane interconnection.

It is an advantage of the present invention that all of the multiplexing optics may be timed off of a single clock, allowing for all of the data transitions along an optical signal path(s)/fiber(s) to be in phase. Therefore, a single clock/data recovery (CDR) module may be used at the demultiplexer to properly recover all of the data signals along a single path/(fiber).

Other and further advantages and aspects of the present invention will become apparent during the course of the following discussion and by reference to the accompanying drawings.

### BRIEF DESCRIPTION OF THE DRAWINGS

Referring now to the drawings, where like numerals represent like parts in several views:

FIG. 1 is a prior art illustration of the interconnection density problems associated with a conventional electrical backplane;

FIG. 2 illustrates an exemplary SOI-based connection arrangement formed in accordance with the present invention that allows for a substantial reduction in the number of separate connections at the backplane of a communication system by concentrating a plurality of separate electrical signals into a single optical signal path;

FIG. 3 contains a diagram of a complete backplane connector utilizing a plurality of the SOI-based connection arrangements as shown in FIG. 2;

FIG. 4 illustrates an exemplary SOI-based backplane connection of the present invention, the embodiment of FIG. 4 also illustrating the use of optical gain within the backplane;

FIG. 5 illustrates an exemplary SOI-based connection arrangement formed in accordance with the present invention that is used to convert a plurality of condensed optical signals into their original, separated electrical signals;

FIG. 6 contains a diagram of a plurality of such arrangements as shown in FIG. 5 that may be used to separate the electrical signals into a number of separate receiver structures;

FIG. 7 illustrates an exemplary transmit section of a system that utilizes a single clock/data recovery (CDR) element for a plurality of separate signal paths;

FIG. 8 illustrates an exemplary receive section for a system using a single CDR element; and

FIG. 9 illustrates an alternative transmit arrangement requiring the use of only a single laser source (and, perhaps, one “sparing” laser source).

### DETAILED DESCRIPTION

In order to understand and appreciate the problems associated with high density electrical interconnection, FIG. 1 is used to illustrate how quickly the number of required electrical connections may grow. In this particular image processing application, a prior art interconnection system 10 is illustrated as comprising a plurality of N sensors 12₁-12_{N} that are used to process a set of electrical image signals, where each sensor 12 generates a plurality of X bits along electrical signal paths 14. It is to be understood that the illustrative use of “sensors” is exemplary only and that the inventive technique to be described below is equally applicable to any high density electrical connection requirement. Referring back to FIG. 1, the plurality of X electrical signal paths 14 exiting from each sensor 12 is thereafter applied as a set of parallel inputs to an associated 1:M fan-out 16. That is, the output from sensor 12₁ is applied as an input to fan-out 16₁, and so on, with the output from sensor 12_{N} applied as an input to fan-out 16_{N}, so that each plurality of X electrical input signals is divided among a plurality of M different communication paths 18. As a result, each 1:M fan-out 16 forms a plurality of X*M separate electrical output signals. Therefore, a total of N*X*M separate electrical signal paths are coupled into an electrical backplane 20 as shown, where as well-known in the art, backplane 20 of system 10 is used as the interconnection module between systems that need to communicate with each other.

In a common example, X=10, M=24 and N=500. Using these numbers, a total of 120,000 separate electrical signal paths are required at backplane 20. This is a conservative estimate, and many applications require an even greater number of “pinouts” along a backplane. Inasmuch as most applications utilize differential signaling, this number could easily be doubled. In addition to these signal connections, separate “power” and “ground” connections are also required. The various noise issues associated with crosstalk between these signals, as mentioned above, also limits the density in terms of signal lines per inch of backplane space. Moreover, this high density arrangement has been found to dissipate a significant amount of power, as a result of the number of components required as well as the packing density that is attempted to maintain minimal size requirements. The overall system “power budget” is an important factor to be considered when designing an interconnection scheme for such a system, where it is desired to keep the power dissipation associated with interconnection as low as possible.

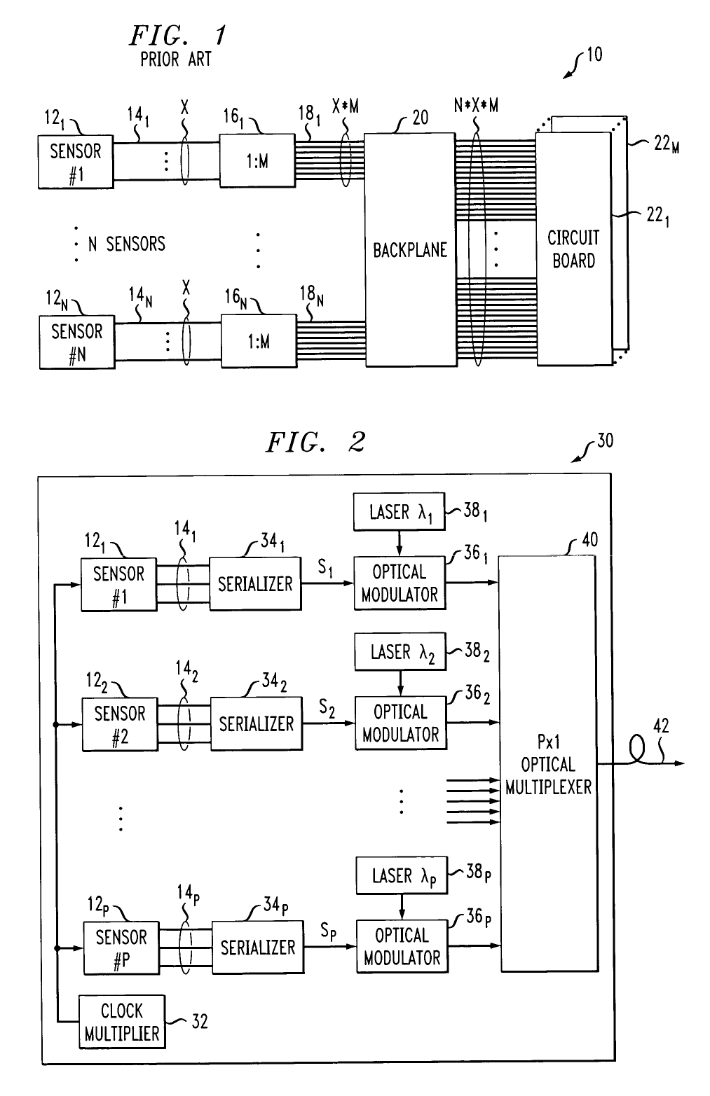

FIG. 2 illustrates an exemplary SOI-based electrical/optical signal concentrator 30 formed in accordance with the present invention that significantly reduces the number of separate signal leads, as well as power dissipation at a backplane interconnection. For the sake of comparison, it will be presumed that the inventive arrangement is used for the same plurality of sensors 12₁-12_{N} as discussed above. A first step in “concentrating” the number of separate electrical signal paths that are required is to form groups of “P” sensors from the total plurality of N sensors. “P” is an arbitrary value (typically 2, 4, 8, 16, etc.) that is selected, as discussed below, by determining the balance between the optical complexity on a single SOI-based structure and the number of separate structures used to provide the complete interconnection. Referring to FIG. 2, a first group of P sensors 12₁-12_{P} is shown, where this set of P sensors is controlled by a single clock multiplier 32 to ensure that the sensors are synchronized to the same data rate. As above, each sensor 12₁-12_{P} generates a plurality of X separate signals along a plurality of signal paths 14. Each plurality of X separate signals are subsequently applied as an input to a serializer 34. As shown in FIG. 2, a separate serializer 34 is associated with each sensor, where serializer 34₁ is coupled to the output of sensor 12₁, encoder 34₂ is coupled to the output of serializer 12₂, and so on, with serializer 34_{P} coupled to the output of sensor 12_{P}.

As is known in the art, a serializer will convert a plurality of separate “parallel” signal paths into serial form, providing a single output signal, denoted “S” in FIG. 2, that comprises the same data, only in serial form. Although not shown in FIG. 2, a plurality of encoders may be used in association with the serializers so as to “encode” the incoming plurality of X data bits into a serial stream of M output data bits. The use of such an encoder is considered an optional part of this invention. Until this point, the processes involved in concentrating the data are still occurring in the electrical domain. In accordance with the present invention, a further advance in the ability to simplify the interconnection between systems is accomplished by now converting these serialized electrical signals into the optical domain. Referring to FIG. 2, each serialized data signal S₁-S_{P} is applied as the “data” input to an associated optical modulator 36, with signal S₁ applied as the data input to optical modulator 36₁, signal S₂ applied as the data input to optical modulator 36₂, and so on, with signal S_{P} applied as the data signal input to optical modulator 36_{P}. These serialized optical signals do not suffer from the bandwidth*distance issues of their prior art electronic counterparts. Moreover, the combination of the optical modulators, driver and laser will typically dissipate approximately 300 mW for a plurality of M fan-outs, while their electronic counterpart will typically dissipate about 100 mW*M channels. If M=24, this power dissipation is 2.4 W, compared to 0.3 W for the optical arrangement of the present invention. Various types of optical modulators are known in the art and may be used to perform this function, such as (for example), MOSCAP electro-absorption (EA) modulators, Mach-Zehnder Interferometer (MZI) MOSCAP devices, PN or PIN MZI modulators, tunable ring resonators, and the like.

It is an important feature of the present invention that the plurality of P optical modulators 36 are integrated within the same SOI-based structure as the associated plurality of serializers 34. Recent advances in the monolithic integration of electronics and optics in SOI-based structures, as disclosed in, for example, U.S. Pat. No. 6,845,198 issued on Jan. 28, 2005 and assigned to the assignee of this application, permits a significant reduction in the space required to perform such signal concentration.

A plurality of P separate CW laser sources 38₁-38_{P} are used in association with optical modulators 36₁-36_{P}, respectively, to transform the input electrical data signals into output optical data signals. These laser sources each operate at a different wavelength (λ₁, λ₂, . . . , λ_{P}), where the wavelength spacing and availability of sources may be factors that influence the selected value of “P”. That is, if P=4, only four laser sources are required and their operating wavelengths may be well spaced. However, in order to accommodate a large number of N original electrical sensors, this value of P would result in a relatively large number of separate SOI-based structures being required (e.g., if N=500, 150 separate structures would be needed). Alternatively, if P=20, twenty separate laser sources are required, which then need to operate with less of a spacing between adjacent wavelengths (perhaps introducing optical crosstalk problems). However, the use of twenty such laser/modulator arrangements on each SOI-based substrate significantly reduces the number of total substrates (e.g., if N=500, only 25 SOI-based substrates are required). It is to be understood that any arrangement may be used in accordance with the present invention and is preferably at the discretion of the person developing a particular implementation. In most cases, these laser sources 38 comprise separate components that are coupled to the SOI structure. As advances are made in this technology, however, it is anticipated that these sources may also be incorporated within the same SOI-based substrate used to form the above-described electrical and optical components.

As a result of the optical modulation process, a plurality of P optical output signals are generated by modulators 36₁-36_{P} and applied as separate inputs to a P×1 wavelength division multiplexer (WDM) 40, where WDM 40 is also formed as part of the same SOI-based substrate. The plurality of P separate optical signals, each operating at a different wavelength, are thereafter combined onto a single optical output signal path 42, where this path may preferably comprise an optical fiber but may also comprise an integrated optical waveguide, a free space optical signal, or any suitable optical signal path. In comparison to the arrangement of FIG. 1, this single optical connection 42 thus replaces a large number of separate electrical signal traces that would traditionally be required for connection of this same group of P sensors 12 to an electrical backplane.

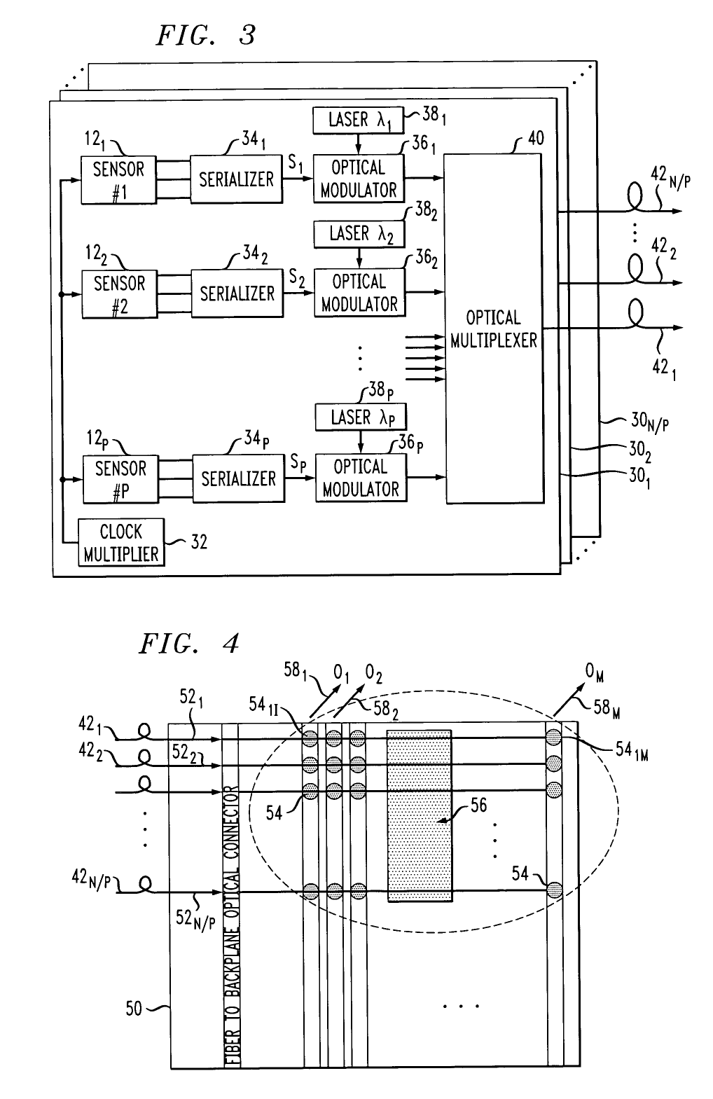

In order to achieve full interconnection, therefore, a plurality of N/P concentrator arrangements 30 may be utilized to provide communication for all N sensors 12 (or other electrical components, as desired) within the system. FIG. 3 illustrates the complete structure of such an interconnection arrangement, where a plurality of concentrators 30₁-30_{N/P} are shown. As mentioned above, each concentrator 30 is coupled to a separate group of P sensors 12 so that all sensors are accommodated. Presuming that N=500 and P=20, a total of 25 separate concentrators would thus be required. As shown, the output from this complete arrangement is a set of N/P waveguides (fibers) 42. Since each optical waveguide/fiber is a separate communication path, it is an advantage of the arrangement of the present invention that the same set of wavelengths may be re-used for each multiplexer 40. Indeed, it is possible to “share” the same laser sources 38 across multiple concentrators 30, with separate waveguides created to couple the signals into each concentrator.

In comparison to the prior art, therefore, the complete plurality of N*X*M separate electrical signal paths (which may be on the order of at least 120,000 for N=500, X=10 and M=24) have been replaced by N/P optical fibers (where if P=20, the required number of fibers is 25). The reduction in interconnection complexity, size and power dissipation achieved with the SOI-based concentration arrangement of the present invention is thus considered to be a significant advance in the state of the art.

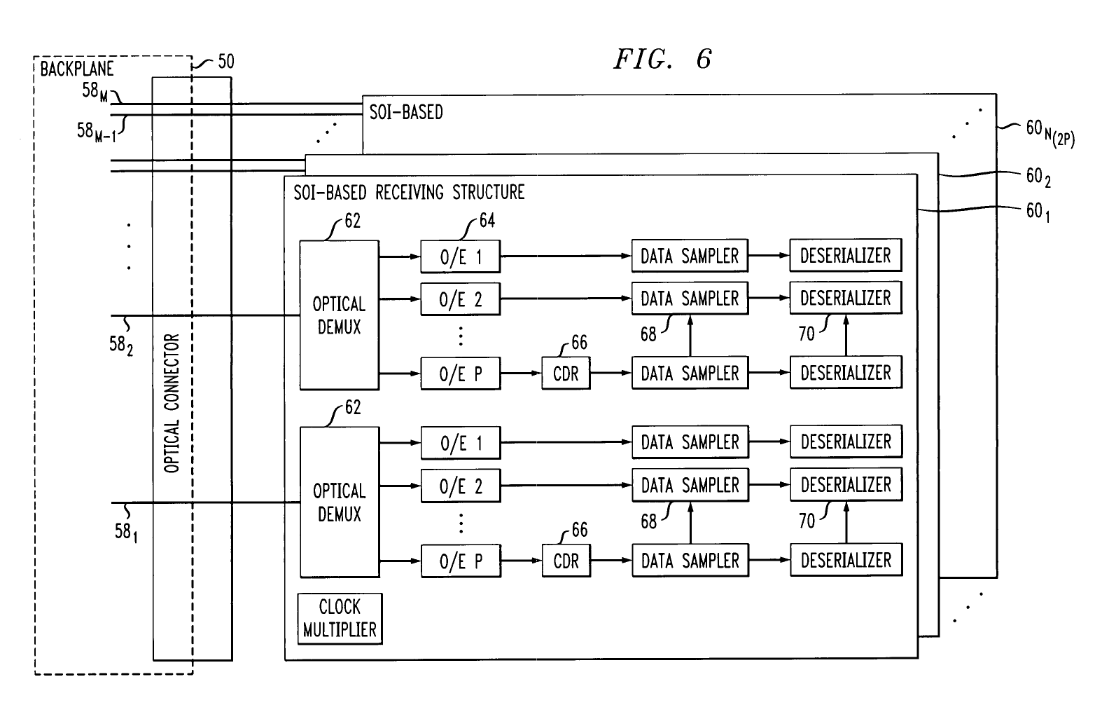

Referring to FIG. 4, an exemplary SOI-based optical backplane 50 is illustrated that may be used to affect the interconnection of an incoming plurality of N/P optical signal paths/fibers 42 (from the arrangement of FIG. 3) to an associated plurality of M receiving arrangements (as shown in FIG. 6). In accordance with the present invention, each incoming optical path 42 is coupled into a separate optical waveguide path 52 formed along backplane 50. A plurality of M separate optical signal taps 54 are disposed along each waveguide path 52 so as to allow for the propagating optical signal to be coupled into each one of the M receiving arrangements. In particular, a plurality of M separate optical signals O₁, O₂, . . . O_{M} are tapped off into a separate set of optical signal paths 58 (for example, optical fibers). In accordance with the present invention, each optical tap 54 provides the same information along its associated signal path 58 to each receiver arrangement. Unlike electrical buses, where the address selects the board that receives the information (with the rest of the boards tri-stated to ignore that signal), optical backplane 50 delivers the same information to all receiving arrangements, at essentially the same time.

It is desirable to maintain the optical power delivered to each receiving arrangement at essentially the same level. Therefore, it is possible to design the optical taps to accommodate this need. That is, optical tap 54₁₁ along waveguide 52₁ may be configured to remove 1/M of the input signal, and so on, with the last optical tap 54_{1M} thus coupling all of the remaining power. Essentially, the taps along a given waveguide 52 are configured to evenly distribute the optical signal power between all M receiving arrangements.

A further improvement in this system may be accomplished in accordance with the present invention by adding a region of optical gain material 56 at a predetermined location along backplane 50. For example, after M/2 signals have been out-coupled by the first M/2 optical taps 54, the remaining M/2 power level optical signal may pass through the region of optical gain 56. Region 56 may comprise, for example, an optically-pumped arrangement such as an erbium-doped arrangement, that may essentially restore full power to the propagating signal. As shown, gain region 56 is formed so that the entire plurality of waveguides 52₁-52_{N/P} pass through the amplifying material. In this case, each optical tap is able to tap off an increased power level signal. It is to be understood that the use of such a gain region (or multiple gain regions) is at the discretion of the system designer.

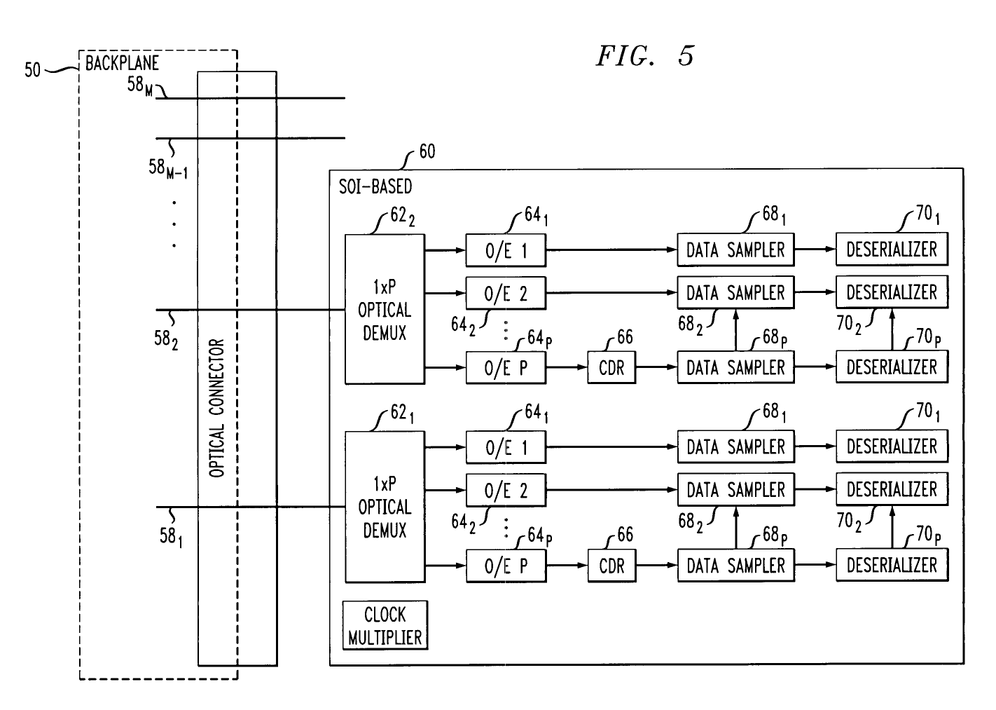

An arrangement formed in accordance with the present invention for connecting with optical backplane 50 and converting the “concentrated” number of optical signals into their original electrical counterparts is illustrated in FIGS. 5 and 6. FIG. 5 illustrates in particular an exemplary receiving SOI-based structure 60 that is used, in this case, with a pair of fibers 58₁ and 58₂ applied as inputs to receiving SOI-based structure 60. As shown, the optical signal propagating along fiber 58₁ is applied as an input to a first optical wavelength demultiplexer 62₁. In accordance with the present invention, each demultiplexer 62 utilizes the same number of output paths P as associated with the input multiplexer 40, so as to demultiplex the separate wavelength signals λ₁-λₚ onto a plurality of P separate output paths.

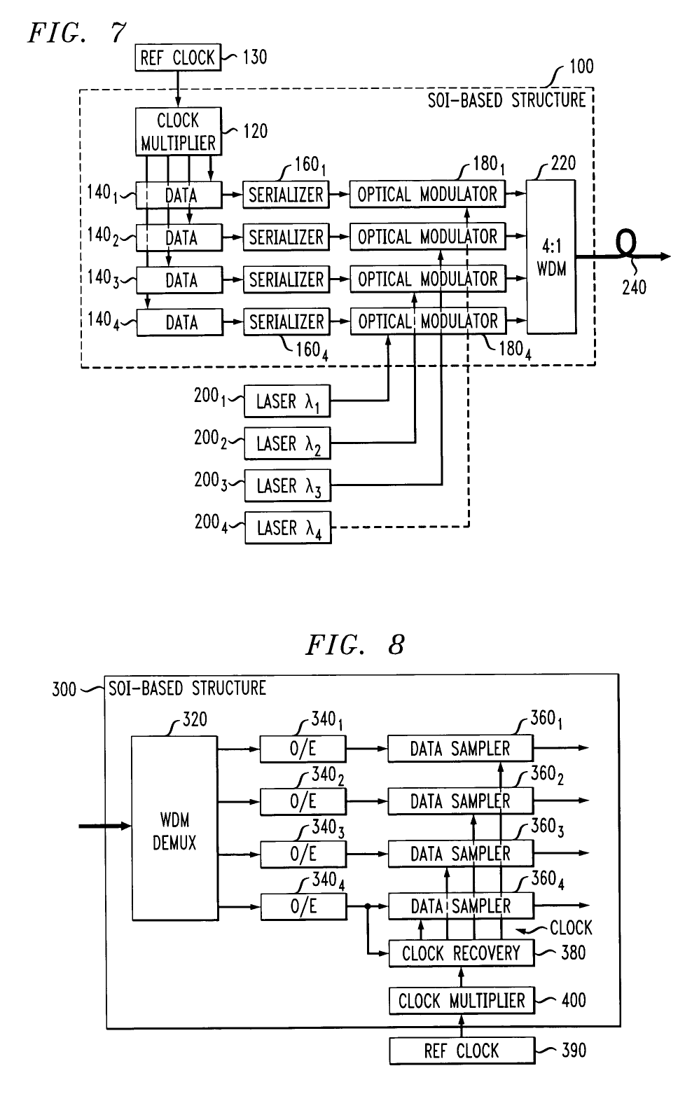

Each de-multiplexed optical output signal is thereafter converted into its electrical form by utilizing a conventional opto-electronic converter 64 (such as, for example, a photodiode). As shown, a plurality of P such converters 64 are coupled to the outputs from each demultiplexer 62. In order to properly recover the transmitted data, it is necessary to “recover” the clock signal used to create the data in the first place. As shown in FIG. 5, it is an additional advantage of the present invention a single clock/data recovery (CDR) module 66 may be used to recover the clock signal for all of the data that had been transported along a common optical signal path (fiber). The recovered clock signal is then applied as an input to an associated plurality of P data samplers 68, with the outputs from data samplers 68 thereafter applied as inputs to a plurality of P separate deserializers 70 to recover the original electrical data signals. It is to be understood that if a plurality of encoders were used in forming the transmitted signals, a companion plurality of decoders will be required and used in association with the plurality of P deserializers 70. A detailed description of an exemplary clock recovery arrangement is contained hereinafter in association with the discussion of FIGS. 7 and 8. As with the arrangement of concentrator 30 described above, a distinct advantage of the present invention is the ability to integrate the various optical and electrical demultiplexing components in a single SOI-based structure, thus reducing the complexity, size and power dissipation associated with the entire signal recovery system.

In order to recover the full plurality of N original signals, a number of such receivers 60 is required. In the particular arrangement as shown in FIG. 5, with two groups of P signals being recovered through each SOI-based receiver structure 60, it is proposed that N/(2P) such structures are required, as shown in FIG. 6. As with the arrangement for providing the concentration as discussed above in association with FIGS. 2 and 3, the ability to integrate the optical components and electrical components in a single board (such as an SOI-based optoelectronic circuit arrangement) significantly reduces the complexity of the inventive structure.

FIG. 7 illustrates, as mentioned above, a particular embodiment of a transmit arrangement for providing electrical signal concentration in accordance with the present invention allows for single clock signal to perform recovery of a plurality of data signals. In accordance with the present invention, each modulated optical output signal from a concentrator 30 will travel on a common media (optical fiber, optical backplane, optical PWB, etc.). Therefore, each of the signals will travel exactly the same physical distance. In this case, there will likely be dispersion along the optical media, causing the data transitions to arrive at slightly different times. Typical dispersions at 1550 nm are approximately 20 ps/km/nm. For one hundred meters, this translates to 2 ps for every nanometer of wavelength separation. At 1310 nm, the dispersion is much less (about 4 ps/km/nm).

On the receiver end, the WDM signal will be demultiplexed in the manner discussed above, with the electrical output then applied as an input to an electrical transimpedance amplifier. The individual data path lengths through the receiver SOI-based structure is also very well controlled (as with the transmitter) and thus the path lengths are nearly identical.

With all of these parameters, therefore, it is possible to utilize a single clock/data recovery module (CDR) to recover the multiple data streams, where the use of a single CDR results in saving an enormous amount of power. It is also possible to create fixed (or tunable) timing offsets between each data stream to account for path length differences of the entire transmit-receiver path. An example of this would be a first transmitter at 1547 nm and a second transmitter at 1557 nm, transmitting over a distance of 100 meters. If each data stream was launched with zero phase difference (with respect to the data transitions), after 100 meters of fiber the phase separation would be 20 ps. Thus, the launch phase relationship can be adjusted such that one pulse lags the other by 20 ps at the modulator (a similar adjustment in phase can be performed at the receiver).

FIG. 7 illustrates an exemplary transmit section of a system that allows for a single CDR to be used at an associated receiver to recover a plurality of transmitted data signals. The transmit section, as discussed above, utilizes a single SOI-based substrate 100 to implement both the electronic and photonic components of the transmitter. The electronic components include a clock multiplier 120 and a plurality of separate input data streams 140 (in this illustration, four separate data streams considered as equivalent to the “sensor” inputs described hereinabove), where clock multiplier 120 is controlled by an external reference clock 130 and is used to control the data transmission rates on each data stream 140. Each clocked data stream 140 is then applied as a separate input to a serializer 160 and the electrical output signals from the plurality of serializers 160 are then supplied as inputs to a plurality of separate optical modulators 180, each modulator using a separate CW laser optical input signal 200 (each signal 200 being at a different wavelength). The modulated optical signals are then applied as inputs to an optical combiner 220 and multiplexed onto a single output optical signal path 240.

FIG. 8 illustrates an exemplary associated receive section of a system using a single clock recovery module in accordance with the present invention. The receive section also comprises a single SOI-based structure 300 for implementing both the electronic and photonic components of the receiver. As shown, the input multiplexed optical signal (as transmitted by an arrangement such as shown in FIG. 7), is first applied as an input to an optical WDM demultiplexer 320 which functions to separate each optical signal onto a separate wavelength path, applying each demultiplexed signal to a separate photodetection arrangement 340 to convert the received optical signal into its electronic equivalent. The separate electrical signals are then applied as inputs to a plurality of data samplers 360. As shown in FIG. 8, the output from a single photodetection arrangement is also applied as an input to a clock recovery module 380 (where, in accordance with the present invention, only a single module is required). A clock multiplier 400 is applied as a second input to clock recovery module 380, where an external (and optional) reference clock 390 may be used to generate/control clock multiplier 400. Clock recovery module 380 thus generates the plurality of different clock signals required by the plurality of data samplers 360, providing as an output a plurality of recovered data signals.

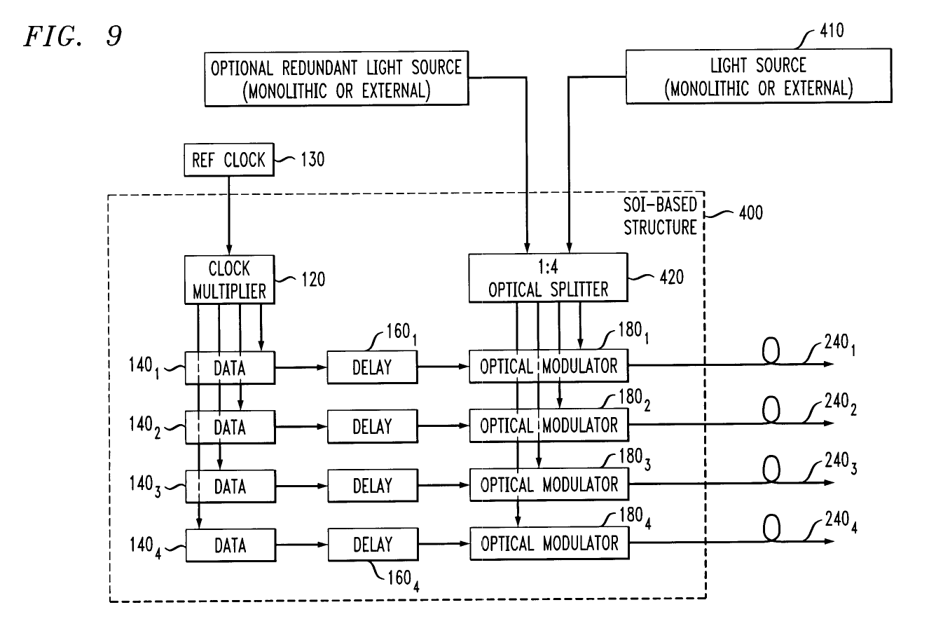

FIG. 9 illustrates an alternative embodiment of the arrangement of FIG. 7, where in this case the separate plurality of laser sources 200 is replaced by single laser source 410 (which may be integrated within the SOI-based structure or used as a discrete device coupled to the structure). A redundant/“sparing” light source 420 may also be used in the event of a failure of source 410. Referring to FIG. 9, the output from source 410 is applied as an input to an optical splitter 420, where splitter 420 is formed as a portion of the SOI-based structure and functions to divide the incoming optical signal into a set of signals of essentially equal power. In the particular embodiment of FIG. 9, a set of four separate optical signals is formed. Each of these signals, it is to be understood, is operating at the same wavelength, with only the power being split by element 420. These optical signals are applied as inputs, as discussed above, to the plurality of optical modulators 180. In this case, since the same wavelength is used to modulate each incoming data signal, a set of four separate optical signal paths/(fibers) 240₁-240₄ is used to carry the output signals. Thus, a savings in the number of laser sources is seen as a trade-off with the number of separate optical signal paths that are required. Additionally if the signal path/fiber connecting the transmit sections to the receive section is made of waveguides having closely matched lengths (such as, for example, in a ribbon fiber connector), then the transmitter embodiment as shown in FIG. 9 may be used in conjunction with a single CDR receiver, as described above. Again, each of these decisions in terms of the number of elements to combine on a single SOI substrate is at the discretion of the system designer.

It is to be understood that the SOI-based optical interconnection arrangement of the present invention is applicable to any situation where a large number of electrical signals are required to be connected between boards. That is, the “sensors” discussed above may comprise virtually any electrical component, such as A/D converters, D/A converters, transmitters, arrays of transmitters, detectors, etc.). Moreover, the data flow may be bi-directional, allowing for the connection structure to be used in a transceiver arrangement. Indeed, it is intended that the scope of the present be limited only by the claims appended hereto.

What is claimed is:

1. A silicon-on-insulator (SOI)-based connection arrangement for use with a plurality of N separate electrical signal paths to reduce the number of connections required at a system interconnection, the connection arrangement comprising
a plurality of P serial elements, each serial element formed on a single SOI-based substrate, the plurality of P serial elements for receiving a plurality of X parallel data bits of an associated electrical data signal and generating as an output a single electrical signal path exhibiting a serially-transmitted electrical data signal;
a plurality of P optical modulators, each optical modulator formed on the same SOI-based substrate as the plurality of P serial elements and driven by a separate one of the serially-transmitted electrical data signals to generate a plurality of P optical data signals; and
a P×1 optical multiplexer formed on the same SOI-based substrate, the P×1 optical multiplexer for combining the plurality of P separate optical data signals onto a single optical signal path as the output of the SOI-based connection arrangement.

2. The SOI-based connection arrangement as defined in claim 1 wherein the arrangement further comprises a plurality of P discrete laser sources associated with the plurality of P optical modulators in a one-to-one relationship, the laser sources each operating at a different wavelength and providing the optical input signal to each modulator.

3. The SOI-based connection arrangement as defined in claim 1 wherein the arrangement further comprises a plurality of P integrated optical signal sources, each optical signal source applied as a separate input to an optical modulator of the plurality of P optical modulators.

4. The SOI-based connection arrangement as defined in claim 1 wherein each serial element of the plurality of P serial elements further comprises a signal encoder for encoding the plurality of X input signal bits into a plurality of M output signal bits, wherein a plurality of P signal encoders are also integrated on the same SOI-based substrate.

5. The SOI-based connection arrangement as defined in claim 1 wherein the single output signal path comprises an optical fiber.

6. The SOI-based connection arrangement as defined in claim 1 wherein the single output signal path comprises an optical waveguide.

7. An SOI-based optical backplane connector comprising
a plurality of input waveguides, each waveguide for receiving as a separate input an optically multiplexed data signal;
a series of optical taps disposed along each input waveguide; and
a plurality of output signal paths for connecting the plurality of optically multiplexed data signals into an additional group of receiving communication devices, wherein each optical tap along a single input waveguide is used for coupling the received optically multiplexed data signal into an associated, separate output signal path.

8. An SOI-based optical backplane connector as defined in claim 7 wherein the series of optical taps are weighted so as to couple an essentially uniform amount of optical power into the plurality of output signal paths as distributed across a single input waveguide.

9. An SOI-based optical backplane connector as defined in claim 7 wherein the SOI-based substrate is formed to comprise an optical gain element disposed so as to intersect the plurality of input waveguides in at least one position between adjacent optical taps.

10. An SOI-based optical connection arrangement responsive to a plurality of optically multiplexed data signals for recovering therefrom a plurality of original electrical data signals, the connection arrangement comprising
an optical demulitplexer for separating a plurality of P optically multiplexed optical signals propagating along a single transmission path into a plurality of P separate optical signals, the optical demultiplexer integrated within an SOI-based structure;
a plurality of P opto-electronic converting devices, each formed within the SOI-based structure and coupled to a separate one of the recovered optical data signals to form a plurality of P electrical data signals;
a clock/data recovery module formed within the SOI-based structure and coupled to the optical demultiplexer to recover a clock signal therefrom;
a plurality of P data samplers formed within the SOI-based structure and associated in a one-to-one relationship with the plurality of P opto-electronic converting devices and further coupled to the clock/data recovery module to generate a plurality of P re-timed data signals; and
a plurality of P deserializers, each deserializers formed within the SOI-based substrate and coupled to receive a separate one of the re-timed data signals for converting the series data stream into a parallel bit data stream.

11. An SOI-based optical connection arrangement as defined in claim 10 wherein the arrangement further comprises a plurality of P decoders formed within the SOI-based substrate and associated in a one-to-one relationship with the plurality of P deserializers for converting a received plurality of M serial data bits into a plurality of X parallel data bits.
